(19) United States
(12) Patent Application Publication
(10) Pub. No.: US 2026/0118893 A1
(43) Pub. Date: Apr. 30, 2026

(54) Methods and Apparatus for Diagnosis on Mass Flow Controller

(71) Applicant: MKS Inc., Andover, MA (US)

(72) Inventors: Junhua Ding, Boxborough, MA (US); Michael L'Bassi, Sterling, MA (US)

(21) Appl. No.: 18/925,907

(22) Filed: Oct. 24, 2024

(51) Int. Cl. G05D 7/06

(52) U.S. Cl. CPC G05D 7/0635

(57) ABSTRACT

Mass flow controllers and associated methods are provided. A mass flow controller includes a control valve configured to control flow of a fluid in a flow path and first and second flow sensors. The second flow sensor includes a pressure sensor adjacent a flow restrictor disposed in the flow path. A controller is configured to control actuation of the control valve. The controller is configured to determine a first mass flow rate based on one or more first fluid flow parameters detected by the first flow sensor, determine a second mass flow rate based on one or more second fluid flow parameters detected by the second flow sensor, calculate an orifice area of the flow restrictor based on the determined first mass flow rate, and compare a nominal orifice area of the flow restrictor with the calculated orifice area to assess a condition of the second flow sensor.

### BACKGROUND

A mass flow controller (MFC) is an important component for gas delivery to a process tool in the semiconductor industry. Traditionally, if an MFC has an issue, the MFC is removed from the process tool for verification and calibration, which can require considerable downtime of the process tool and can be associated with considerable financial loss.

In general, the MFC controls and monitors the rate of fluid flow (e.g., of a gas or vapor) in real time so that the flow rate of the mass of a gas passing through the device can be metered and controlled. A traditional pressure-based MFC includes a flow control valve and a pressure drop element, such as a flow nozzle. The MFC can measure flow rate with use of one or more pressure sensors. The MFC controls the rate of flow based on a given setpoint, usually predetermined by the user or an external device, such as a semiconductor tool. The setpoint can be changed with each step of a process.

Certain MFC devices, such as MKS Low Flow MFC (LFMFC) and Hybrid MFC (HMFC) devices, have a flow self-verification feature which uses two different flow measurement mechanisms. One of the flow measurement mechanisms may use a critical flow nozzle and a pressure sensor to determine flow rate.

### SUMMARY

Mass flow control devices and methods are provided which are capable of self-diagnosing and/or self-correcting in real-time for advanced semiconductor manufacturing. Such devices and methods can make use of distinct flow measurements and a self-diagnosis algorithm that can be applied in situ to assess a condition of a less-accurate sensor based on measurements from a more-accurate sensor. Such devices and methods may also be used to correct the less-accurate sensor with respect to measurements from the more-accurate sensor.

A mass flow controller includes a control valve configured to control flow of a fluid in a flow path and first and second flow sensors in the flow path. The second flow sensor includes a pressure sensor adjacent a flow restrictor disposed in the flow path. The mass flow controller further includes a controller configured to control actuation of the control valve. The controller is configured to determine a first mass flow rate based on one or more first fluid flow parameters detected by the first flow sensor, determine a second mass flow rate based on one or more second fluid flow parameters detected by the second flow sensor, calculate an orifice area of the flow restrictor of the second flow sensor based on the determined first mass flow rate, and compare a nominal orifice area of the flow restrictor of the second flow sensor with the calculated orifice area to assess a condition of the second flow sensor.

The first and second flow sensors may be of distinct flow measurement types (e.g., rate of pressure decay type, thermal flow type, critical flow type, etc.). For example, the first flow sensor can be a rate of pressure decay flow sensor (e.g., a pressure sensor associated with a chamber defining a volume for rate of pressure decay measurement) or a thermal flow sensor. The second flow sensor, which includes a pressure sensor adjacent a flow restrictor, can be a critical flow sensor.

The second flow sensor can be downstream in the flow path from the control valve, the first flow sensor, or both the control valve and the first flow sensor.

The controller can be configured to compare the nominal orifice area to the calculated orifice area by calculating a ratio of the nominal orifice area to the calculated orifice area.

The orifice area can be a throat area of a nozzle of the flow restrictor of the second flow sensor. The throat area of the nozzle can be nonadjustable, e.g., having a fixed, nominal area, but with deposition of reactive gases or impurities the area can become smaller.

The controller can be configured to assess the condition of the second flow sensor according to the ratio of the nominal throat area A to the calculated throat area A′, wherein severe clogging of the nozzle of the flow restrictor is indicated by the following:

$$\vert A / {A}^{′} - 1 \vert > e 1$$

where e1 is a predetermined threshold.

The controller can be configured to send a warning alarm when severe clogging of the nozzle of the flow restrictor is indicated, wherein the warning alarm is sent to a user, a process tool, or both.

The controller can be configured to calculate the second mass flow rate Q2 according to the following:

$$Q 2 = k 2 * A * P 2$$

where A is the throat area of the nozzle of the flow restrictor, P2 is a pressure measured by the pressure sensor adjacent the flow restrictor, and k2 is a coefficient related to a property of the fluid and temperature.

The controller can be configured to calculate the throat area A′ of the nozzle of the flow restrictor according to the following:

$${A}^{′} = Q 1 / ( k 2 * P 2 )$$

where Q1 is the determined first mass flow rate, P2 is the pressure measured by the pressure sensor adjacent the flow restrictor, and k2 is the coefficient related to a property of the fluid and temperature.

The controller can be configured to control actuation of the control valve based on the determined second mass flow rate calculated using the calculated throat area A′ of the nozzle of the flow restrictor of the second flow sensor.

The mass flow controller can further include a flow body or housing, the control valve and the first and second flow sensors disposed within the flow body or housing.

A method of providing for mass flow control includes controlling flow of a fluid in a flow path with a control valve. A first mass flow rate is determined based on one or more first fluid flow parameters detected by a first flow sensor in the flow path. A second mass flow rate is determined based on one or more second fluid flow parameters detected by a second flow sensor in the flow path, the second flow sensor comprising a pressure sensor adjacent a flow restrictor disposed in the flow path. The method further includes calculating an orifice area of the flow restrictor of the second flow sensor based on the determined first mass flow rate and comparing a nominal orifice area of the flow restrictor of the second flow sensor with the calculated orifice area to assess a condition of the second flow sensor.

The first and second flow sensors can be of distinct flow measurement types. For example, the first flow sensor can be a rate of pressure decay flow sensor or a thermal flow sensor and the second flow sensor a critical flow sensor.

Comparing the nominal orifice area to the calculated orifice area can include calculating a ratio of the nominal orifice area to the calculated orifice area.

The orifice area can be a throat area of a nozzle of the flow restrictor of the second flow sensor.

The condition of the second flow sensor can be assessed according to the ratio of the nominal throat area A to the calculated throat area A′, wherein severe clogging of the nozzle of the flow restrictor is indicated by the following:

$$\vert A / {A}^{′} - 1 \vert > e 1$$

where e1 is a predetermined threshold.

The method can further include sending a warning alarm when severe clogging of the nozzle of the flow restrictor is indicated, wherein the warning alarm is sent to a user, a process tool, or both.

The second mass flow rate Q2 can be calculated according to the following:

$$Q 2 = k 2 * A * P 2$$

where A is the throat area of the nozzle of the flow restrictor, P2 is a pressure measured by the pressure sensor adjacent the flow restrictor, and k2 is a coefficient related to a property of the fluid and temperature.

The calculated throat area A′ of the nozzle of the flow restrictor can be calculated according to the following:

$${A}^{′} = Q 1 / ( k 2 * P 2 )$$

where Q1 is the determined first mass flow rate, P2 is the pressure measured by the pressure sensor adjacent the flow restrictor, and k2 is the coefficient related to a property of the fluid and temperature.

The method can further include controlling actuation of the control valve based on the determined second mass flow rate calculated using the calculated throat area A′ of the nozzle of the flow restrictor.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic of an example of a mass flow controller.

FIG. 2 is a schematic of another example of a mass flow controller.

FIG. 3 is a flow diagram of an example method of diagnosing a flow sensor of the mass flow controller of FIG. 1 or FIG. 2.

### DETAILED DESCRIPTION

A description of example embodiments follows.

A traditional pressure-based mass flow controller (MFC) includes a flow control valve and a pressure drop element, such as a flow nozzle/orifice. Deposition can happen on the flow nozzle/orifice inside the MFC due to reactive gases, impurity in the gas, or back stream from the process tool. If the flow nozzle/orifice gets clogged, the flow measurement will be incorrect as the relationship between the pressure and the flow rate has changed. As the flow nozzle/orifice size becomes smaller, the chance increases that it gets clogged.

If another upstream flow measurement is available and unaffected, it can be used to correct the downstream measurement of the flow nozzle/orifice. Certain self-verifying MFC devices, such as MKS Low Flow MFC and MKS Hybrid MFC device, can correct the flow error caused by clogging of the flow nozzle/orifice using the other unaffected flow measurement but only to a certain degree. There is a need for improved MFC devices that are capable of self-diagnosis and/or self-correction, such that a condition of the flow nozzle/orifice can be assessed and, optionally, corrected. In addition, it is desirable that the MFC can alert a user or a process tool when the flow nozzle/orifice is severely clogged.

Mass flow controllers having two different flow measurement mechanisms, e.g., MKS Low Flow MFC and MKS Hybrid MFC, can be adapted to provide for self-diagnosis. In such devices, one of the flow measurement mechanisms employs pressure-based flow measurement, e.g., critical flow through a flow nozzle/orifice. The other mechanism can employ a different flow measurement, such as rate of pressure decay measurement or thermal flow measurement. The flow measurement employed by the other mechanism can be of the type that generally provides for more accurate mass flow measurements but may be undesirable for use as the control mechanism for some applications. In such situations, the mass flow controller can use the other flow measurement mechanism to recalculate the flow nozzle/orifice size (e.g., nozzle/orifice area) to determine clogging conditions of the flow nozzle/orifice. This can provide an automatic self-diagnosis method to check the health of the pressure-based flow measurement elements in the MFC, especially for clogging inside the flow nozzle/orifice.

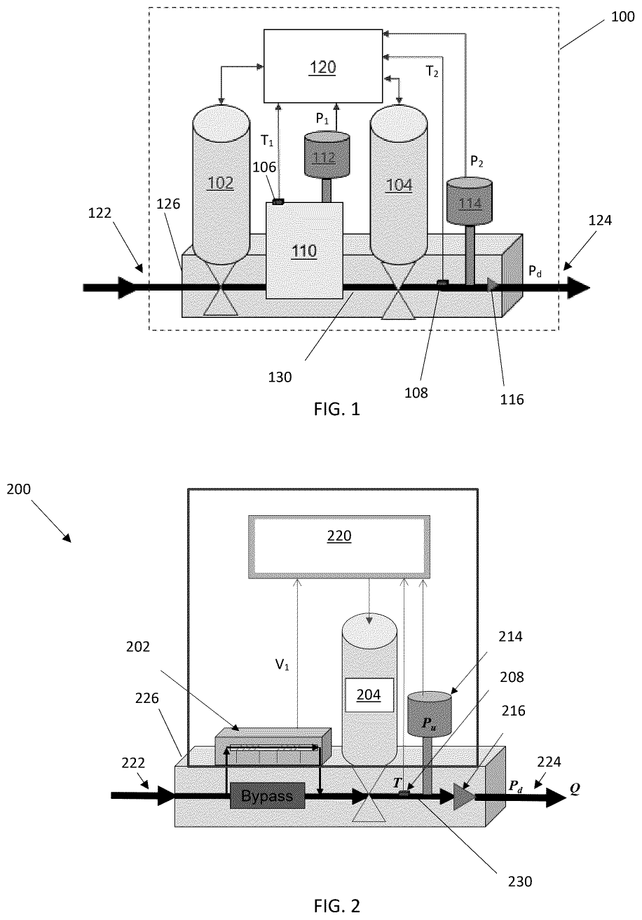

An example configuration of a prior mass flow controller capable of self-diagnosis is shown in FIG. 1. A mass flow controller (MFC) 100 receives a flow of a fluid at an inlet 122, and the fluid flows through a body 126 of the device. The MFC 100 includes an upstream valve 102 and a downstream valve 104. As illustrated, both valves 102, 104 are adjustable control valves; however, the upstream valve 102 can alternatively be an on/off-type valve.

As used herein, the term “control valve” refers to a valve that can provide for a controllable range of open states, likely between on and off states, and excludes on/off-type valves. The openness of an adjustable control valve can be controlled in response to a control signal, and a flow rate through the valve can be controlled. Adjustable control valves include proportional control valves. Examples of suitable control valves for use as an adjustable control valve in the provided devices include solenoid valves, piezo valves, and step motor valves.

The MFC further includes a chamber 110, a temperature sensor 106 that detects a temperature (T1) of a fluid in the chamber 110, and a pressure sensor 112 that detects fluid pressure in the chamber 110. The chamber 110 is disposed or part of the body 126 between the upstream valve 102 and the downstream control valve 104 and is provided for rate of pressure decay measurements. The MFC further includes a flow restrictor 116, such as a critical flow nozzle or an orifice. A second pressure sensor 114 and, optionally, a second temperature sensor 108 are disposed downstream of the control valve 104 and upstream of the critical flow nozzle 116. The second pressure sensor 114 is provided for pressure measurements. Fluid flows through a flow path 130 and out of the MFC at an outlet 124. The second temperature sensor 108 is provided to detect a temperature (T2) of fluid in the flow path 130.

The MFC 100 further includes a controller 120, which can receive sensed temperature and pressure information from sensors 106, 108, 112, 114 and provide control signals to operate valves 102 and 104 to regulate pressure and/or flow of the fluid through the flow path 130 to a setpoint. The MFC 100 can obtain flow measurements using either or both a rate of pressure decay and critical flow measurement methods. Rate of pressure decay methods are generally more accurate and have the advantage of being inherently gas independent; however, such methods can be limited to low-flow control applications due to volume limitations of the chamber 110 and can be inefficient in some circumstances.

In the example configuration shown in FIG. 1, the pressure sensor 112, which is configured for detection of rate of pressure decay measurements, provides for one measurement type, and the pressure sensor 114, which is configured for detection of pressure under critical flow conditions, provides for another measurement type. In such a configuration, the one or more fluid flow parameters that are detected can include pressure measurements of fluid flowing in the flow path 130.

With the MFC configuration shown in FIG. 1, a rate of pressure decay flow measurement (Q1) based on pressure measurements from sensor 112 can be used as a flow calibration standard to calibrate a critical flow measurement (Q2) based on pressure measurements from sensor 114, as further described in U.S. patent application Ser. No. 18/448,791, filed Aug. 11, 2023, and titled “Method and Apparatus for Automatic Self Calibration of Mass Flow Controller,” the entire teachings of which are incorporated herein by reference.

Another example of determining a verification flow rate based on a rate of decay of pressure and recalibrating pressure-based flow control based on the verification flow rate is described in U.S. Patent Publication No. 2024/0201713 A1, published Jun. 20, 2024, and titled “Method and Apparatus for Mass Flow Control,” the entire teachings of which are incorporated herein by reference.

For example, a first flow measurement, based on the rate of pressure decay principle, can be calculated as a function of the pressure measurement (P₁) obtained from sensor 112, as follows, where k0 and k1 are constants at a constant temperature:

$$Q 1 = f d ( {P}_{1} ) = k 0 + k 1 \frac{d {P}_{1}}{dt} \qquad ( 1 )$$

A second flow measurement, based on the critical flow principle, can be calculated as a function of the pressure measurement (P₂) obtained from sensor 114, as follows, where C0 and C1 are constants:

$$Q 2 = f p ( {P}_{2} ) = C 0 + C 1 * {P}_{2} \qquad ( 2 )$$

A flow calibration process can determine a relationship between the input signal (P₂) and the output signal (Q2) for the second measurement method using the flow measurement (Q1) obtained from the first method.

While the above example describes a rate of pressure decay measurement being used as the flow-calibration standard, it is possible for the critical flow-based measurement to be used as the calibration standard instead, for example, to calibrate the flow rate measured by the rate of pressure decay method using pressure sensor 112.

Methods of determining a mass flow rate of a fluid based on pressures sensed upstream (and optionally downstream) of a flow restrictor are generally known in the art. The flow restrictor can be of any suitable type for restricting a flow of the fluid, including, for example, a critical flow nozzle, a laminar flow element, a porous media flow restrictor, an orifice, a valve, or a tube.

Another example configuration of a mass flow controller capable of self-diagnosis is shown in FIG. 2. The mass flow controller 200 includes a thermal flow sensor 202, a control valve 204, and a pressure sensor 214. The pressure sensor 214 is disposed downstream of the control valve 204 and upstream of a flow restrictor 216, such as a critical flow nozzle. The flow of fluid through a flow path 230 of the device is controlled by the control valve 204. A controller 220, such as a micro-processor, can control actuation of the control valve 204 based on either or both of a monitored mass flow (V₁), as sensed by the thermal flow sensor 202, and a monitored pressure (Pᵤ), as sensed by the pressure sensor 214, either of which can be regulated to a setpoint. As illustrated, a flow of fluid (e.g., gas) is received at inlet 222 of a flow body (e.g., housing) 226 of the device and fluid flow out of the device at outlet 224.

Thermal flow sensors typically include a heat source, over which the gas being measured passes, and operate based on temperature measurements obtained of the gas. For example, a thermal flow sensor can include a sensor tube at which thermal elements are disposed. The thermal elements can be, for example, coiled resistors, which wrap around the sensor tube and are heated to a temperature above the ambient temperature. As gas flows through the sensor tube, the gas, which is typically at ambient temperature, has a cooling effect on the coils and lowers their temperature as a function of mass flow. The flowing gas cools an upstream coil more than a downstream coil and, thus, a mass flow rate of the gas can be determined based on a measured temperature difference between the coils, as indicated by a measured difference in resistances between the coils. Examples of thermal flow sensors are further described in U.S. Pat. No. 5,461,913.

Thermal flow sensors can be advantageous for use in mass flow control applications, but can be unsuitable for some applications (e.g., such as with reactive gases) and can be prone to drift.

In the example configuration shown in FIG. 2, the thermal flow sensor 202 provides for one measurement type, and the pressure sensor 214, which is configured for detection of pressure under critical flow conditions, provides for another flow measurement type. In such a configuration, the one or more fluid flow parameters that are detected can include mass flow rate measurements based on voltage outputs of the thermal pressure sensor and pressure measurements of fluid flowing in the flow path 230.

With the MFC configuration shown in FIG. 2, one of a pressure based critical flow measurement and a thermal flow based measurement can be used as the calibration standard to calibrate the other of the two sensors, as further described in U.S. patent application Ser. No. 18/448,791, filed Aug. 11, 2023, titled “Method and Apparatus for Automatic Self Calibration of Mass Flow Controller,” the entire teachings of which are incorporated herein by reference.

For example, a first flow measurement based on thermal mass flow sensor can be calculated as a function of an output voltage (V1) of a thermal mass flow sensor (e.g., sensor 202), as follows, where k0 and k1 are constants:

$$Q 1 = f t ( V 1 ) = k 0 + k 1 * V 1 \qquad ( 3 )$$

A second mass flow measurement, based on the critical flow principle, can be calculated as in Eqn. 2. Where the thermal flow based measurement is used as the standard, a flow calibration process can determine a relationship between the input signal (P₂) and the output signal (Q2) for the second measurement method using the flow measurement (Q1) obtained from the first method. Where the pressure based critical flow measurement is used as the calibration standard, a relationship between the input signal (V1) and the output signal (Q1) of the thermal mass flow reading can be determined using the flow measurement (Q2) from the critical flow method.

A mass flow controller having two different flow measurement mechanisms, e.g.

MKS Low Flow MFC and MKS Hybrid MFC, can be adapted to provide for self-diagnosis. FIGS. 1 and 2 illustrate example MFC configurations having two different flow measurement mechanisms. One of the mechanisms employs a pressure-based flow measurement, e.g., critical flow through a flow nozzle/orifice. There is a pressure sensor (e.g., pressure sensor 114, 214) upstream to the flow nozzle/orifice (e.g., flow restrictor 116, 216) to measure the upstream pressure (e.g., P2, Pu). The relationship between the flow (Q2) and the measured pressure (P2) can be expressed by the following equation:

$$Q 2 = k 2 * A * P 2 \qquad ( 4 )$$

where A is the throat area of the flow nozzle/orifice and k2 is a coefficient related to gas property and temperature. In other words, the calculation of flow (Q2) is dependent, among other parameters, on throat area A of the flow nozzle/orifice. Conditions for critical flow through the nozzle/orifice (116, 216) are generally present when pressure upstream of the nozzle/orifice (P2, Pu) is at least twice pressure downstream (Pd) of the nozzle/orifice, which can be expressed as P2≥2Pd (FIG. 1) or Pu≥2Pd (FIG. 2). Typically, when measuring pressure (P2, Pu) and temperature (T2, T) upstream to the nozzle, the flow is proportional to the upstream pressure if the size of nozzle/orifice does not change.

The throat area of the flow nozzle/orifice (e.g., flow restrictor 116, 216) is generally nonadjustable, e.g., having a fixed, nominal area, but with deposition of, for example, reactive gases or impurities, the area can become smaller and eventually clogged.

The other flow measurement method can be using an upstream pressure rate of decay (ROD) method (FIG. 1) or thermal flow sensing (FIG. 2), either of which provides an independent flow measurement as Q1. Typically, both measured flows Q1 and Q2 should be the same or the error between them very small, i.e. Q1=Q2.

If Q1 is considered as the primary flow measurement and better (e.g., more accurate) than the second flow measurement Q2, one can use Q1 to correct the Q2 calculation. If the pressure (P2, Pᵤ) sensed by the pressure sensor is assumed to be accurate, then the throat area of the flow nozzle/orifice A is decreased due to the clogging of the flow nozzle/orifice. For example, reactive gases such as WF6 or SiH4 could decompose and deposit inside the flow nozzle/orifice, leading to clogging. As a result, the new throat area A′ of the flow nozzle/orifice can be recalculated based on the other flow measurement Q1 as:

$${A}^{′} = Q 1 / ( k 2 * P 2 ) \qquad ( 5 )$$

If A′ has a small change compared to the original value A, the device can still be used on the process tool and the pressure-based flow measurement can use the new A′ value in Eq. (4) to calculate the measured flow Q2. If A′ is changed considerably, i.e.:

$$\vert A / {A}^{′} - 1 \vert > e 1 \qquad ( 6 )$$

where e1 is a predetermined threshold value, which indicates that the flow nozzle/orifice is severely clogged. The device can send a warning alarm to the tool user before the flow nozzle/orifice is completely clogged or the device failed on the process tool.

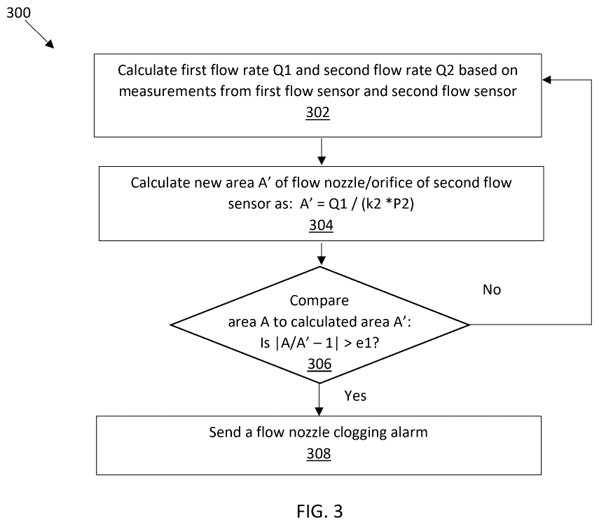

An example MFC calibration procedure 300 is shown in FIG. 3. A controller of the MFC (e.g., controller 120, 220) can calculate first flow rate Q1 and second flow rate Q2 based on measurement (302). At (304), a new throat area A′ of the flow nozzle/orifice can be calculated based on the first flow measurement Q1, which may be assumed to represent true flow. The new area A′ can be calculated based on Q1 according to Eq. (5) above. The old (e.g., initial) area A of the flow nozzle/orifice is compared to the calculated new area A′ (306). The old area A can be the original or nominal value of the orifice area A of the flow restrictor as, for example, stored on the device. If A′ is changed considerably, i.e. relative to the predetermined threshold according to Eq. (6), this indicates that the flow nozzle/orifice is severely clogged. The device can then send a warning alarm (308), e.g., to the process tool and/or the user before the flow nozzle/orifice is completely clogged or has failed on the process tool. If A′ has a small change compared to the original value A, the device can still be used on the process tool and the pressure-based flow measurement can, for example, use the new A′ value in Eq. (4) to calculate the measured flow Q2.

The MFC devices and methods described can provide for several advantages. In particular, the provided devices and methods simplify MFC maintenance and enable it to occur on the process tool, i.e. in situ self-diagnosis. Avoiding the downtime that occurs when an MFC is removed from the process tool can provide for significant financial savings. The provided devices and methods can provide an automatic self-diagnosis method to check the health of the pressure-based flow measurement in the MFC, especially for the clogging inside the flow nozzle/orifice.

Advantageously, devices and methods can calculate orifice size (e.g., orifice area A′) of the flow nozzle/orifice in real time, based on true flow, using upstream pressure measurement (e.g., P2, Pd) and another flow measurement. The area A′ can be calculated using Eq. (5), as described above. The calculated orifice area A′ can be compared to original orifice area A stored in the device. If the calculated area A′ shrinks by a pre-determined amount (threshold amount), e.g., 30% relative to the original orifice area A, the device can raise an alarm.

The device may be configured to allow the user to choose the point at which degradation of the nozzle/orifice, e.g., clogging, is too much, such that an alarm should be raised. The device may be provided with a default setting for the threshold, e.g., 20%, 30%, etc., but allow the user to define the setting for a particular application.

In MFC devices that employ pressure-based flow measurement, e.g., critical flow through a flow nozzle/orifice, and another, more accurate, flow measurement, one typically wants to use the pressure-based flow measurement (e.g., Q2) for flow control, because it is faster than the other flow measurement (e.g., Q1). Once can use the more accurate flow measurement (Q1) to tell if the pressure-based flow measurement (Q2) is off. One can determine when (e.g., based on a threshold criterion) the device is no longer suitable (e.g., not providing accurate flow measurements) for controlling flow to a process tool in a particular application.

In a typical Low Flow MFC device employing a rate of decay flow sensor and a pressure-based flow sensor using a flow restrictor, if the orifice of the flow restrictor is clogged, one can still use the device by correcting the pressure-based flow measurement (Q2) based on the rate of decay measurement (Q1). Such approaches, however, hide the underlying problem of nozzle clogging by self-correcting or self-verifying the pressure-based flow measurement (Q2).

Several prior approaches for self-verification of pressure-based flow controllers define the problem as a difference in flow rates as measured by two flow sensors. Examples of such approaches include U.S. Pat. No. 9,846,074, which describes a system and method of monitoring flow through mass flow controllers in real time, and U.S. Pat. No. 9,471,066, which describes a system and method of providing pressure insensitive self verifying mass flow controller. Additional examples are provided in U.S. Pat. Nos. 10,031,005 and 10,801,867, which describe methods and apparatus for self verification of pressure-based flow controllers. There, the flow restriction of the pressure-base flow controller is provided by a control valve orifice and thus has a controllable area. Although such prior approaches may use orifice area A of a flow restrictor in calculating the pressure-based flow rate, they do not identify a clogging condition of a nozzle/orifice based on a calculated orifice area A.

Advantageously, the present approach can narrow the problem of incorrect flow measurement down to only the flow nozzle of the flow restrictor. This allows the device to signal the user what the cause of problem is.

In any configuration, the self-diagnosis results, e.g., the calculated orifice area values, can be saved in the MFC's storage memory, e.g. flash memory or EEPROM memory etc. The MFC can report the saved results/values back to a host processor or a user. Devices and methods can also use calculations of the orifice area repeated over time and, for example, saved in the MFC's storage memory, to make a prediction.

For example, calculated orifice area values can be stored in a lookup table or provided in a chart, which can then be used to predict when the orifice area of a particular device is likely to become severely clogged, as defined by a pre-determined threshold. Similarly, based on an observed orifice area trend with time, the user, or the device itself, could predict when the device will fail.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A mass flow controller, comprising:
a control valve configured to control flow of a fluid in a flow path;
a first flow sensor in the flow path;
a second flow sensor in the flow path, the second flow sensor comprising a pressure sensor adjacent a flow restrictor disposed in the flow path; and
a controller configured to control actuation of the control valve, the controller configured to:
determine a first mass flow rate based on one or more first fluid flow parameters detected by the first flow sensor;
determine a second mass flow rate based on one or more second fluid flow parameters detected by the second flow sensor;
calculate an orifice area of the flow restrictor of the second flow sensor based on the determined first mass flow rate; and
compare a nominal orifice area of the flow restrictor of the second flow sensor with the calculated orifice area to assess a condition of the second flow sensor.

2. The mass flow controller of claim 1, wherein the first and second flow sensors are of distinct flow measurement types.

3. The mass flow controller of claim 2, wherein the first flow sensor is a rate of pressure decay flow sensor.

4. The mass flow controller of claim 2, wherein the first flow sensor is a thermal flow sensor.

5. The mass flow controller of claim 1, wherein the second flow sensor is downstream in the flow path from the control valve and the first flow sensor.

6. The mass flow controller of claim 1, wherein the controller is configured to compare the nominal orifice area to the calculated orifice area by calculating a ratio of the nominal orifice area to the calculated orifice area.

7. The mass flow controller of claim 6, wherein the orifice area is a throat area of a nozzle of the flow restrictor of the second flow sensor.

8. The mass flow controller of claim 7, wherein the controller is configured to assess the condition of the second flow sensor according to the ratio of the nominal throat area A to the calculated throat area A′, wherein severe clogging of the nozzle of the flow restrictor is indicated by the following:
$$\vert A / {A}^{′} - 1 \vert > e 1$$
where e1 is a predetermined threshold.

9. The mass flow controller of claim 8, wherein the controller is configured to send a warning alarm when severe clogging of the nozzle of the flow restrictor is indicated, wherein the warning alarm is sent to a user, a process tool, or both.

10. The mass flow controller of claim 7, wherein the controller is configured to calculate the second mass flow rate Q2 according to the following:
$$Q 2 = k 2 * A * P 2$$
where A is the throat area of the nozzle of the flow restrictor, P2 is a pressure measured by the pressure sensor adjacent the flow restrictor, and k2 is a coefficient related to a property of the fluid and temperature.

11. The mass flow controller of claim 7, wherein the controller is configured to calculate the throat area A′ of the nozzle of the flow restrictor according to the following:
$${A}^{′} = Q 1 / ( k 2 * P 2 )$$
where Q1 is the determined first mass flow rate, P2 is the pressure measured by the pressure sensor adjacent the flow restrictor, and k2 is the coefficient related to a property of the fluid and temperature.

12. The mass flow controller of claim 11, wherein the controller is configured to control actuation of the control valve based on the second mass flow rate calculated using the calculated throat area A′ of the nozzle of the flow restrictor of the second flow sensor.

13. The mass flow controller of claim 7, wherein the throat area of the nozzle of the flow restrictor is nonadjustable.

14. The mass flow controller of claim 1, further comprising a flow body or housing, the control valve and the first and second flow sensors disposed within the flow body or housing.

15. A method of providing for mass flow control, comprising:
controlling flow of a fluid in a flow path with a control valve;
determining a first mass flow rate based on one or more first fluid flow parameters detected by a first flow sensor in the flow path;
determining a second mass flow rate based on one or more second fluid flow parameters detected by a second flow sensor in the flow path, the second flow sensor comprising a pressure sensor adjacent a flow restrictor disposed in the flow path;
calculating an orifice area of the flow restrictor of the second flow sensor based on the determined first mass flow rate; and
comparing a nominal orifice area of the flow restrictor of the second flow sensor with the calculated orifice area to assess a condition of the second flow sensor.

16. The method of claim 15, wherein the first and second flow sensors are of distinct flow measurement types.

17. The method of claim 15, wherein the first flow sensor is a rate of pressure decay flow sensor or a thermal flow sensor.

18. The method of claim 15, wherein comparing the nominal orifice area to the calculated orifice area includes calculating a ratio of the nominal orifice area to the calculated orifice area.

19. The method of claim 18, wherein the orifice area is a throat area of a nozzle of the flow restrictor of the second flow sensor.

20. The method of claim 19, wherein the condition of the second flow sensor is assessed according to the ratio of the nominal throat area A to the calculated throat area A′, wherein severe clogging of the nozzle of the flow restrictor is indicated by the following:
$$\vert A / {A}^{′} - 1 \vert > e 1$$
where e1 is a predetermined threshold.

21. The method of claim 20, further comprising sending a warning alarm when severe clogging of the nozzle of the flow restrictor is indicated, wherein the warning alarm is sent to a user, a process tool, or both.

22. The method of claim 19, wherein the second mass flow rate Q2 is calculated according to the following:
$$Q 2 = k 2 * A * P 2$$
where A is the throat area of the nozzle of the flow restrictor, P2 is a pressure measured by the pressure sensor adjacent the flow restrictor, and k2 is a coefficient related to a property of the fluid and temperature.

23. The method of claim 19, wherein the calculated throat area A′ of the nozzle of the flow restrictor is calculated according to the following:
$${A}^{′} = Q 1 / ( k 2 * P 2 )$$
where Q1 is the determined first mass flow rate, P2 is the pressure measured by the pressure sensor adjacent the flow restrictor, and k2 is the coefficient related to a property of the fluid and temperature.

24. The method of claim 23, further comprising controlling actuation of the control valve based on the second mass flow rate calculated using the calculated throat area A′ of the nozzle of the flow restrictor.

25. The method of claim 19, wherein the throat area of the nozzle of the flow restrictor is nonadjustable.
